(19) United States
(12) Patent Application Publication
(10) Pub. No.: US 2026/0008503 A1
(43) Pub. Date: Jan. 8, 2026

(54) VEHICLE BODY STRUCTURE

(71) Applicants: Hyundai Motor Company, Seoul (KR); Kia Corporation, Seoul (KR)

(72) Inventors: Seung Min Kang, Hwaseong-si (KR); Sung Woong Ha, Hwaseong-si (KR); Dong Ho Kang, Hwaseong-si (KR); Dong Kyu Kim, Hwaseong-si (KR)

(21) Appl. No.: 18/921,343

(22) Filed: Oct. 21, 2024

(30) Foreign Application Priority Data
Jul. 5, 2024 (KR) 10-2024-0088948

(51) Int. Cl. B62D 25/16; B62D 21/02; B62D 21/11

(52) U.S. Cl. CPC B62D 25/16; B62D 21/02; B62D 21/11

(57) ABSTRACT

A vehicle body structure can include a front side member disposed at both sides of the front of a vehicle body so as to extend in a longitudinal direction of the vehicle body, a suspension support member disposed at an upper side of the front side member, a fender apron member disposed at the upper side of the front side member in such a shape as to cover the suspension support member at the front and the side of the vehicle body, and a coupling member configured to connect the suspension support member to the front side member and the fender apron member in front of the suspension support member.

### CROSS-REFERENCE TO RELATED APPLICATIONS

This application claims the benefit of Korean Patent Application No. 10-2024-0088948, filed on July 5, 2024 with the Korean Intellectual Property Office, the disclosure of which is herein incorporated by reference in its entirety.

### TECHNICAL FIELD

The present disclosure relates to the structure of a front part of a vehicle body.

### BACKGROUND

A purpose built vehicle (PBV) is a vehicle in which, to respond to the market flow of low-volume production of various types of products, the vehicle is divided into a drive module related to driving and a life module forming various forms of passenger and cargo space according to market needs, and the modules are coupled to each other.

Therefore, there is an advantage of being able to quickly produce vehicles that meet market needs by changing only the life module.

To reduce the cost of vehicle production while increasing the utilization of space for passengers and cargo, PBVs tend to have a relatively small overall length, an increased wheelbase, and a driver's seat disposed as far forward as possible.

As a result of the above development trends, PBVs tend to have difficulty providing sufficient space for a front collision accident in front of the vehicle.

The matters disclosed in this section are merely for enhancement of understanding of the general background of the present disclosure and should not be taken as an acknowledgment or any form of suggestion that such matters form the related art already publicly known, available, or in use.

### SUMMARY

An embodiment of the present disclosure can provide a vehicle body structure configured such that first row seats, including a driver's seat, are disposed as far forward as possible to maximize interior space, as in a box car, a PBV, and the like, whereby it is possible to effectively disperse and support the collision energy resulting from a front collision even in a vehicle in which it is difficult to secure sufficient space to absorb the collision energy in the event of the front collision at the front of the vehicle body, and therefore it can be possible to sufficiently secure safety performance against the front collision of the vehicle.

Advantages of the present disclosure are not necessarily limited to the aforementioned advantages, and other unmentioned advantages can be understood by those skilled in the art based on the following description.

In accordance with an embodiment of the present disclosure, the above and other advantages can be accomplished by the provision of a vehicle body structure including front side members disposed at both sides of the front of a vehicle body so as to extend in a longitudinal direction of the vehicle body, a suspension support member disposed at an upper side of the front side member, a fender apron member disposed at the upper side of the front side member in such a shape as to cover the suspension support member at the front and the side of the vehicle body, and a coupling member configured to connect the suspension support member to the front side member and the fender apron member in front of the suspension support member.

The coupling member may include a front additional member disposed in front of the suspension support member so as to extend in the longitudinal direction of the vehicle body, the front additional member being coupled to the fender apron member, and a vertical member disposed so as to extend in a vertical direction, the vertical member being configured to connect a coupling portion of the fender apron member and the front additional member to the front side member.

The front apron member may be coupled to the front additional member in the state in which at least a part of the front apron member is inserted in a front end of the front additional member.

The front additional member may be formed in a shape forming a closed section in a longitudinal direction thereof, and the front additional member may be provided at the front end thereof with a space forming portion configured to form a space into which the fender apron member is inserted and a flange configured to support the rear of the inserted fender apron member in surface contact.

The suspension support member may be n-shaped with both ends coupled to the front side member in a state of being spaced apart from each other in the longitudinal direction of the vehicle body.

The suspension support member may include a first leg portion having a lower end coupled to the front side member, a second leg portion having a lower end coupled to the front side member at the rear of the first leg portion, and a leg connection portion formed so as to extend in the longitudinal direction of the vehicle body, the leg connection portion being configured to connect upper ends of the first leg portion and the second leg portion to each other.

The suspension support member may be coupled to a wheel house panel such that a space in which the first leg portion, the leg connection portion, and the second leg portion of the suspension support member are connected to each other is formed between the wheel house panel and the suspension support member.

At the rear of the portion where the leg connection portion and the second leg portion of the suspension support member are connected to each other, a dash cross member may be installed with a dash panel therebetween.

At the rear of the front side member, a dash lower longitudinal member may be installed so as to extend in the longitudinal direction of the vehicle body.

A subframe may be mounted to a lower side of the front side member, and a front end module frame may be coupled to the front of the front side member in a state of connecting the front side members to each other.

The subframe may be formed in a quadrangular shape with two sides parallel to the front side member, and the subframe may be provided with subframe front protrusions protruding forward farther than the front side member in front of both sides of the subframe.

An upper portion of the front end module frame may extend in a transverse direction of the vehicle body to connect the front side members to each other, a lower stiffener may be installed between the subframe front protrusions of the subframe, and the front end module frame and the lower stiffener may form an annular structure toward the front of the vehicle body.

The fender apron member may be coupled to a side wall of the front additional member, and the vertical member may be configured to connect lower sides of the fender apron member and the front additional member to an upper side of the front side member.

A front end of the fender apron member may be coupled to a front end of the front side member, and the coupling member may include a front additional member disposed in front of the suspension support member so as to extend in the longitudinal direction of the vehicle body and a vertical member configured to connect the front additional member and the front side member to each other in the vertical direction.

In accordance with an embodiment of the present disclosure, a vehicle body structure can include a front side member, a suspension support member having both ends spaced apart from each other forward and rearward in a longitudinal direction of the front side member so as to be coupled to an upper side of the front side member, a front additional member installed parallel to the front side member in front of the suspension support member, and a vertical member installed so as to extend in a vertical direction, the vertical member being configured to connect a front end of the front additional member to the front side member.

The vehicle body structure may further include a fender apron member extending forward while wrapping around the outside of a vehicle body of the suspension support member so as to be gradually bent inwardly of the vehicle body, the fender apron member being coupled to the front additional member or the front side member.

A subframe, both sides of which form a quadrangle parallel to the front side member, may be coupled to a lower side of the front side member.

The subframe may be provided at each side of the front thereof with a subframe front protrusion protruding forward farther than the front additional member parallel to the front additional member, and a lower stiffener extending in a transverse direction of the vehicle body so as to connect the subframe front protrusions to each other may be installed at the subframe front protrusion.

A front end module frame extending upward and downward and having an upper end connected in a transverse direction of the vehicle body may be coupled to the front ends of the front side members, whereby the front end module frame may form an annular structure toward the front of the vehicle body together with the lower stiffener.

One end of the suspension support member may include a first leg portion coupled to the front side member, the other end of the suspension support member may include a second leg portion coupled to the front side member at the rear of the first leg portion, upper ends of the first leg portion and the second leg portion may be connected to each other via a leg connection portion, and at least a part of the leg connection portion may be formed parallel to the front side member.

### BRIEF DESCRIPTION OF THE DRAWINGS

The above and other features and advantages of the present disclosure can be more clearly understood from the following detailed description taken in conjunction with the accompanying drawings, in which:

FIG. 1 is a front perspective view illustrating a vehicle body structure according to a first embodiment of the present disclosure;

FIG. 2 is a front perspective view showing a subframe mounted to a lower side of the structure of FIG. 1, according to an embodiment of the present disclosure;

FIG. 3 is a front perspective view showing a front end module frame mounted to the front of the structure of FIG. 1, according to an embodiment of the present disclosure;

FIG. 4 is a top view of the structure of FIG. 3, according to an embodiment of the present disclosure;

FIG. 5 is a side view of the structure of FIG. 3, according to an embodiment of the present disclosure;

FIG. 6 is a top perspective view showing only some main components of the structure of FIG. 1, according to an embodiment of the present disclosure;

FIG. 7 is a rear perspective view of the structure of FIG. 6, according to an embodiment of the present disclosure;

FIG. 8 is a bottom perspective view of the structure of FIG. 6, according to an embodiment of the present disclosure;

FIG. 9 is a top view of the structure of FIG. 6, according to an embodiment of the present disclosure;

FIG. 10 is a side view of the structure of FIG. 6, according to an embodiment of the present disclosure;

FIG. 11 is a detailed rear perspective view showing region F11 of FIG. 7, according to an embodiment of the present disclosure;

FIG. 12 is a bottom perspective view showing the region shown in FIG. 11, according to an embodiment of the present disclosure;

FIG. 13 is a sectional view taken along line F13-F13 of FIG. 6, according to an embodiment of the present disclosure;

FIG. 14 is a simplified view showing the sectional structure of FIG. 13, according to an embodiment of the present disclosure;

FIG. 15 is a simplified view showing a second embodiment of the present disclosure as a sectional view of the same region as in FIG. 14; and

FIG. 16 is a simplified view showing a third embodiment of the present disclosure as a sectional view of the same region as in FIG. 14.

### DETAILED DESCRIPTION OF ILLUSTRATIVE EMBODIMENTS

In describing example embodiments disclosed herein, a detailed description of known functions and configurations incorporated herein can be omitted when it may make the subject matter of the present disclosure rather unclear. In addition, the accompanying drawings can be used to aid in ease of understanding various technical features and it can be understood that embodiments relating to the example embodiments disclosed herein are not necessarily limited by the accompanying drawings. As such, the present disclosure can be construed to extend to any alterations, equivalents, and substitutes in addition to those that are particularly set out in the accompanying drawings.

It can be understood that although the terms “first,” “second,” etc. may be used herein to describe various elements, these elements are not necessarily limited by these terms. These terms can be generally used merely to distinguish one element from another.

A singular representation may include a plural representation unless it represents a definitely different meaning from the context.

It can be further understood that the terms “includes”, “has” and the like, when used in this specification, specify the presence of stated features, numbers, steps, operations, elements, parts, or combinations thereof, but do not preclude the presence or addition of one or more other features, numbers, steps, operations, elements, parts, or combinations thereof.

Suffixes such as “module” and “unit” may be used to refer to elements. Use of such a suffix herein can be merely intended to facilitate description of the specification, and the suffix itself is not intended to necessarily have any special meaning or function.

It can be understood that, when an element is referred to as being “connected to” or “coupled to” another element, it may be directly connected to or coupled to the other element, or intervening elements may be present. In contrast, when an element is referred to as being “directly connected to” or “directly coupled to” another element, there are no intervening elements present.

Description will now be given in detail according to example embodiments disclosed herein with reference to the accompanying drawings. For the sake of brief description with reference to the drawings, same or equivalent elements may be provided with same reference numbers, and description thereof perhaps not repeated.

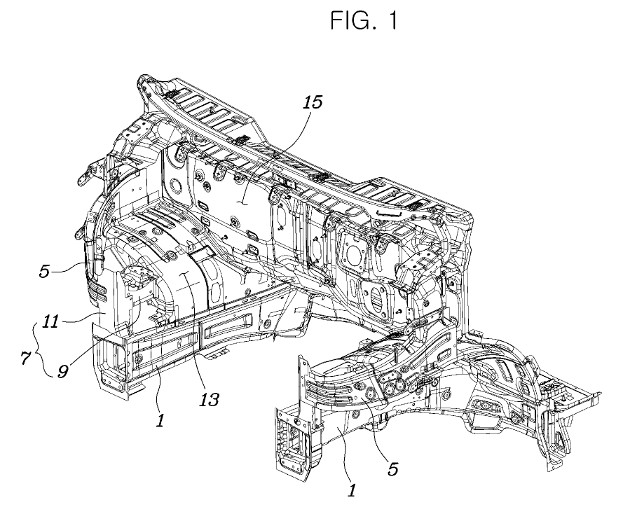

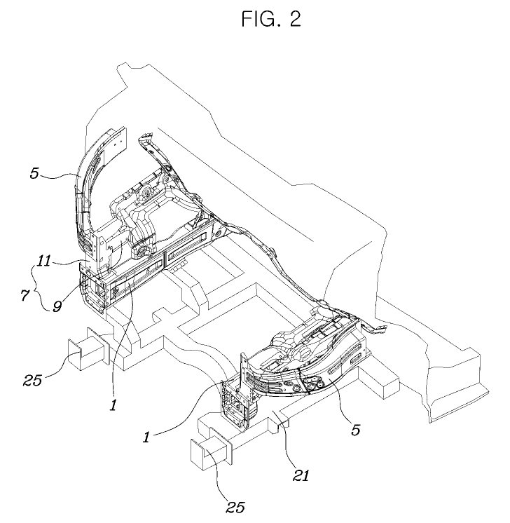

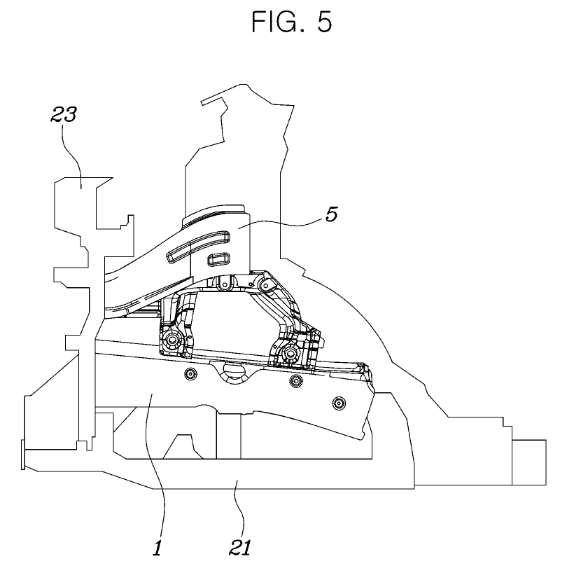

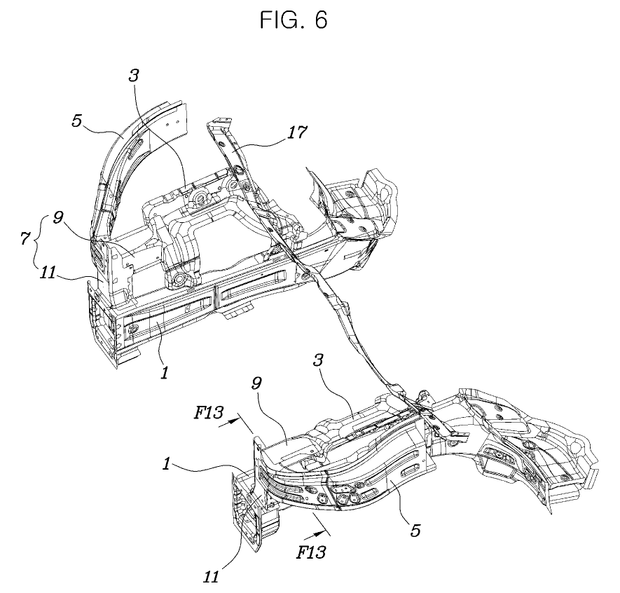

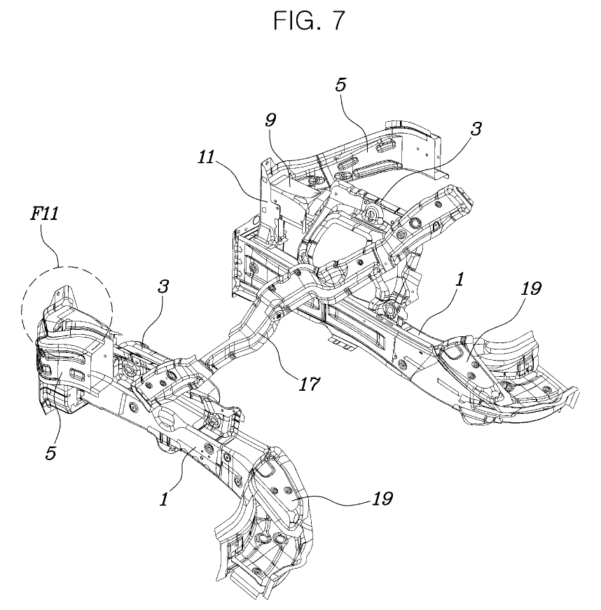

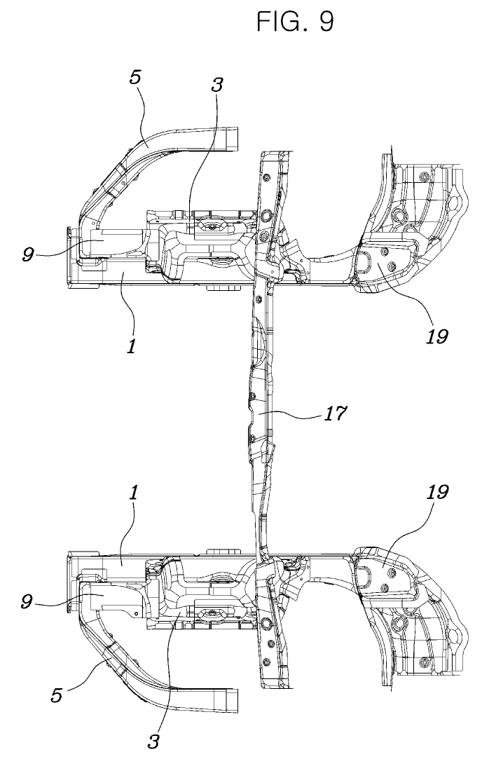

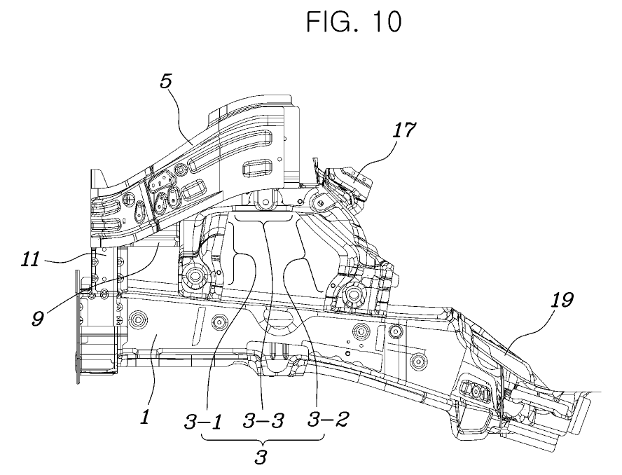

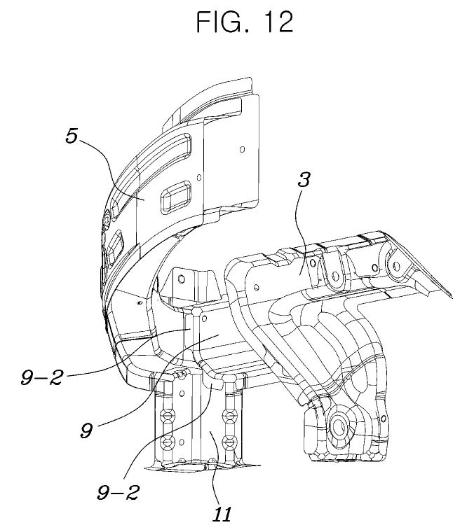

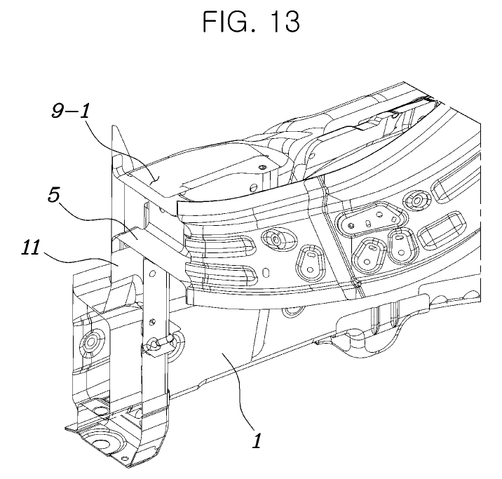

Referring to FIGS. 1 to 14, a first embodiment of a vehicle body structure of the present disclosure includes front side members 1 disposed at both sides of the front of a vehicle body so as to extend in a longitudinal direction of the vehicle body, a suspension support member 3 disposed at an upper side of the front side member 1, a fender apron member 5 disposed at the upper side of the front side member 1 in such a shape as to cover the suspension support member 3 at the front and the side of the vehicle body, and a coupling member 7 connecting the suspension support member 3 to the front side member 1 and the fender apron member 5 in front of the suspension support member 3.

In an embodiment of the present disclosure, the front side member 1, the suspension support member 3, and the fender apron member 5 can be connected to each other by the coupling member 7 in front of the front side member 1.

In an embodiment of the present disclosure, the coupling member 7 can include a front additional member 9 disposed in front of the suspension support member 3 so as to extend in the longitudinal direction of the vehicle body, the front additional member being coupled to the fender apron member 5, and a vertical member 11 disposed so as to extend in a vertical direction, the vertical member connecting the coupling portion of the fender apron member 5 and the front additional member 9 to the front side member 1.

Thus, the suspension support member 3 can be coupled to the fender apron member 5 via the front additional member 9, and the fender apron member 5 and the front additional member 9 can be coupled to the front side member 1 via the vertical member 11, forming a first generally rectangular box structure (among members 1, 3, 9, and 11) at the front side diagonally below the fender apron member 5 (see, e.g., FIGS. 1, 2, 6, 7, and 8).

Thus, when the vehicle body having the structure as described above is subjected to collision energy from the front by a front collision accident or the like, the collision energy is not only dispersed through the front side member 1 and the fender apron member 5, but also dispersed to the suspension support member 3 through the front additional member 9, whereby it is possible to effectively disperse and support the collision energy due to the front collision even in a vehicle having difficulty securing sufficient space to absorb the collision energy.

The front apron member 5 may be coupled to the front additional member 9 in the state in which at least a part of the front apron member is inserted in a front end of the front additional member.

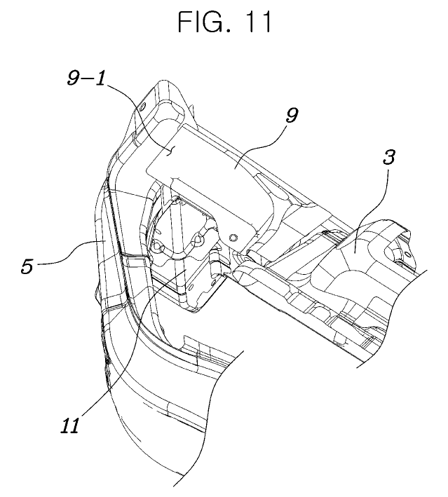

That is, referring to FIGS. 11 to 14, the front additional member 9 may be formed in a shape forming a closed section in a longitudinal direction thereof, and the front additional member 9 can be provided at the front end thereof with a space forming portion 9-1 forming a space into which the fender apron member 5 can be inserted and a flange 9-2 can be for supporting the rear of the inserted fender apron member 5 in surface contact.

Accordingly, an embodiment of the present embodiment can have a structure in which the fender apron member 5 can be coupled to the front additional member 9 in a state of being inserted into the front additional member 9 as described above, thereby excluding a situation in which the connectivity between the fender apron member 5 and the front additional member 9 is deteriorated by destruction of a weld or the like at an early stage of a front collision accident, which makes it difficult to effectively disperse the collision energy, and enabling effective and stable dispersion of the collision energy due to the enhanced connectivity.

For reference, the rear of the fender apron member 5 may be supported by an A-pillar, whereby the fender apron member may be installed so as to effectively support the collision energy transmitted during the front collision accident as described above.

The suspension support member 3 may be n-shaped with both ends coupled to the front side member 1 in a state of being spaced apart from each other in the longitudinal direction of the vehicle.

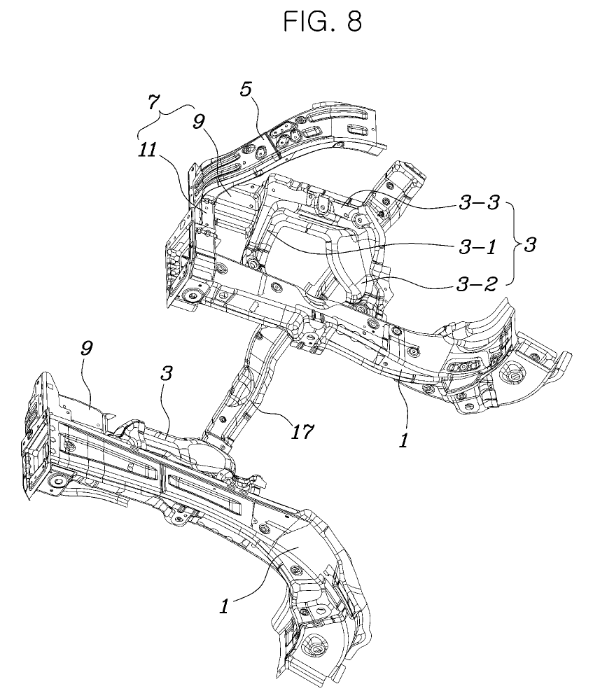

More specifically, the suspension support member 3 may include a first leg portion 3-1 having a lower end coupled to the front side member 1, a second leg portion 3-2 having a lower end coupled to the front side member 1 at the rear of the first leg portion 3-1, and a leg connection portion 3-3 formed so as to extend in the longitudinal direction of the vehicle body to connect upper ends of the first leg portion 3-1 and the second leg portion 3-2 to each other, thereby forming a second generally rectangular box structure (among members/portions 1, 3-1, 3-2, and 3-3) at a side of the vehicle body structure (see, e.g., FIG. 8).

The suspension support member 3 can be coupled to a wheel house panel 13 such that a front suspension support space in which the first leg portion 3-1, the leg connection portion 3-3, and the second leg portion 3-2 of the suspension support member 3 can be connected to each other can be formed between the wheel house panel 13 and the suspension support member 3.

Thus, the suspension support member 3, together with the wheel house panel 13, can have a shape having a closed section extending from the first leg portion 3-1 to the second leg portion 3-2 with an interior space, and may function as a structure having high rigidity. Also, the second generally rectangular box structure (among members/portions 1, 3-1, 3-2, and 3-3) together with the wheel house panel 13, can have a shape having a closed or partially-closed box section that may function as a sub-structure having high rigidity.

For reference, the suspension support member 3 may support a shock absorber of a double wishbone type suspension apparatus or MacPhersen strut type suspension apparatus.

At the rear of the portion where the leg connection portion 3-3 and the second leg portion 3-2 of the suspension support member 3 are connected to each other, a dash cross member 17 may be installed with a dash panel 15 therebetween.

Thus, in the event of a front collision of the vehicle, the collision energy transmitted to the rear via the front additional member 9 can be effectively supported and absorbed by the suspension support member 3, the dash panel 15, and the dash cross member 17.

In particular, the leg connection portion 3-3 of the suspension support member 3 can be formed so as to extend in the longitudinal direction of the vehicle body, whereby the leg connection portion substantially functions as a support member parallel to the front side member 1, and therefore it can be possible to more effectively support and absorb the collision energy transmitted as described above.

At the rear of the front side member 1, a dash lower longitudinal member 19 can be installed so as to extend in the longitudinal direction of the vehicle body.

Accordingly, the dash lower longitudinal member 19 and the dash panel 15 can serve to disperse and support a part of the collision energy transmitted to the rear through the front side member 1.

A center side member and a side sill can be coupled to the rear of the front side member 1, and can serve to mainly support the collision energy.

A subframe 21 can be mounted to a lower side of the front side member 1, and a front end module frame 23 can be coupled to the front of the front side member 1 in a state of connecting the front side members 1 to each other, both of which can be modular components that are modularly connected thereto for providing potential for use in many different PBVs, for example.

For reference, the front end module frame 23 can be a structure that enables integration of a plurality of parts mounted to the front of the vehicle into a single unit, and can serve to support a cooling module, a headlamp, and the like.

The subframe 21 can be formed in a quadrangular shape with two sides parallel to the front side member 1, and the subframe 21 can be provided with subframe front protrusions 25 protruding forward farther than the front side member 1 in front of both sides of the subframe 21.

An upper portion of the front end module frame 23 can extend in a transverse direction of the vehicle body to connect the front side members 1 to each other, a lower stiffener 27 can be installed between the subframe front protrusions 25 of the subframe 21, and the front end module frame 23 and the lower stiffener 27 can form an annular structure A toward the front of the vehicle body, any or all of which can be modular components for providing potential for use of the vehicle body of an embodiment in many different PBVs.

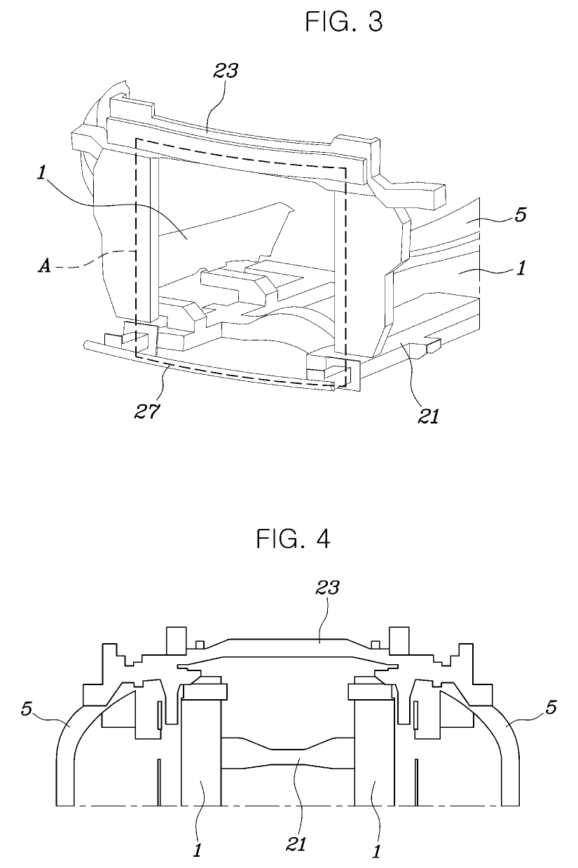

That is, as illustrated in FIG. 3, when the front end module frame 23 and lower stiffener 27 are projected onto an imaginary plane located at the front of the vehicle body, an annular structure A in which the front end module frame 23 forms the upper side and both sides and the lower stiffener 27 forms the lower side can be formed.

The annular structure A can be formed by the front end module frame 23 and the lower stiffener 27 as described above and can provide a solid support structure for the front collision of the vehicle body and can help to effectively disperse the collision energy.

In addition, the subframe 21 can be coupled to the lower side of the front side member 1 so as to support and absorb the collision energy generated in the event of a front collision by dispersing the collision energy together with the front side member 1.

Thus, because a vehicle according to an embodiment of the present disclosure can be able to support and absorb the front collision energy generated as described above by dispersing the front collision energy through the fender apron member 5, the front additional member 9, the suspension support member 3, the front side member 1, and the subframe 21, it can be possible to effectively disperse and support the front collision energy generated in a front collision accident, even in a vehicle in which it is difficult to secure sufficient space to absorb the collision energy in the front collision accident, and thereby sufficiently secure the safety performance of the vehicle against the front collision.

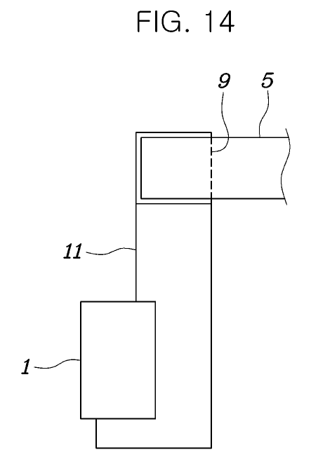

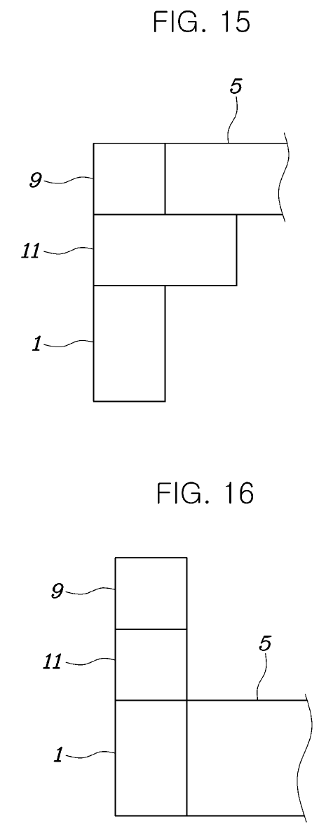

FIG. 15 is a view showing a second embodiment of the present disclosure as a sectional view of the same region as in FIG. 14, wherein the fender apron member 5 can be coupled to a side wall of the front additional member 9, and the vertical member 11 can be configured to connect the lower sides of the fender apron member 5 and the front additional member 9 to the upper side of the front side member 1.

In this case, the fender apron member 5 can be coupled to the side wall of the front additional member 9, and the fender apron member 5 and the front additional member 9 can be connected to the front side member 1 via the vertical member 11, whereby connectivity between the fender apron member 5, the front additional member 9, and the front side member 1 can be strengthened, which can contribute to strengthening the front stiffness of the vehicle.

In addition, FIG. 16 is a view showing a third embodiment of the present disclosure as a sectional view of the same region as in FIG. 14, wherein the front end of the fender apron member 5 can be coupled to the front end of the front side member 1, and the coupling member 7 can include a front additional member 9 disposed in front of the suspension support member 3 so as to extend in the longitudinal direction of the vehicle body and a vertical member 11 connecting the front additional member 9 and the front side member 1 to each other in the vertical direction.

That is, an embodiment of the present embodiment can have a configuration in which the front end of the fender apron member 5 can be directly coupled to the front end of the front side member 1 and in which the front additional member 9 can be located in front of the suspension support member 3 and can be connected to the front side member 1 via the vertical member 11.

In this case, the front section of the front side member 1 can be extended by the fender apron member 5, thereby improving the energy absorption performance at the beginning of collision.

An embodiment of the present disclosure as described above may also be expressed as follows.

That is, the vehicle body structure according to an embodiment of the present disclosure can include a front side member 1, a suspension support member 3 having both ends spaced apart from each other forward and rearward in a longitudinal direction of the front side member 1 so as to be coupled to an upper side of the front side member 1, a front additional member 9 installed parallel to the front side member 1 in front of the suspension support member 3, and a vertical member 11 installed so as to extend in a vertical direction to connect a front end of the front additional member 9 to the front side member 1.

In addition, the vehicle body structure according to an embodiment of the present disclosure may further include a fender apron member 5 extending forward while wrapping around the outside of the vehicle body of the suspension support member 3 so as to be gradually bent inwardly of the vehicle body and to be coupled to the front additional member 9 or the front side member 1.

A subframe 21, both sides of which can form a quadrangle parallel to the front side member 1, can be coupled to a lower side of the front side member 1.

The subframe 21 can be provided at each side of the front thereof with a subframe front protrusion 25 protruding forward farther than the front additional member 9 parallel to the front additional member 9, and a lower stiffener 27 can be extending in a transverse direction of the vehicle body so as to connect the subframe front protrusions 25 to each other and can be installed at the subframe front protrusion 25.

A front end module frame 23 can be extending upward and downward and can be having an upper end connected in a transverse direction of the vehicle body and can be coupled to the front ends of the front side members 1, whereby the front end module frame may form an annular structure toward the front of the vehicle body together with the lower stiffener 27.

One end of the suspension support member 3 can include a first leg portion 3-1 coupled to the front side member 1, the other end of the suspension support member 3 can include a second leg portion 3-2 coupled to the front side member 1 at the rear of the first leg portion 3-1, upper ends of the first leg portion 3-1 and the second leg portion 3-2 can be connected to each other via a leg connection portion 3-3, and at least a part of the leg connection portion 3-3 can be formed parallel to the front side member 1.

As can be apparent from the above description, in a vehicle body structure according to an embodiment of the present disclosure, first row seats, including a driver's seat, can be disposed as far forward as possible to maximize interior space, as in a box car, a PBV, and the like, whereby it can be possible to effectively disperse and support the collision energy resulting from a front collision even in a vehicle in which it is difficult to secure sufficient space to absorb the collision energy in the event of the front collision at the front of the vehicle body, and therefore it can be possible to sufficiently secure safety performance against the front collision of the vehicle.

The advantages of an embodiment of the present disclosure are not necessarily limited to those mentioned above, and other unmentioned advantages can be clearly understood by an ordinary skilled person from the above description.

Although specific example embodiments of the present disclosure have been shown and described above, it can be apparent to those skilled in the art that various modifications and variations can be made in embodiments of the present disclosure without departing from the technical ideas of the present disclosure defined by the appended claims.

What is claimed is:

1. A vehicle body structure comprising:
first and second front side members disposed at both sides of the front of a vehicle body so as to extend in a longitudinal direction of the vehicle body;
a suspension support member disposed at an upper side of the first front side member;
a fender apron member disposed at the upper side of the first front side member in such a shape as to cover the suspension support member at a front and a side of the vehicle body; and
a coupling member configured to connect the suspension support member to the first front side member and the fender apron member in front of the suspension support member.

2. The vehicle body structure according to claim 1, wherein the coupling member comprises:
a front additional member disposed in front of the suspension support member so as to extend in the longitudinal direction of the vehicle body, the front additional member being coupled to the fender apron member; and
a vertical member disposed so as to extend in a vertical direction, the vertical member being configured to connect a coupling portion of the fender apron member and the front additional member to the first front side member.

3. The vehicle body structure according to claim 2, wherein the fender apron member is coupled to the front additional member in a state in which at least a part of the fender apron member is inserted in a front end of the front additional member.

4. The vehicle body structure according to claim 3, wherein the front additional member is formed in a shape forming a closed section in a longitudinal direction thereof, and
wherein the front additional member is provided at the front end thereof with a space forming portion configured to form a space into which the fender apron member is inserted and a flange configured to support a rear of the inserted fender apron member in surface contact.

5. The vehicle body structure according to claim 2, wherein the suspension support member is n-shaped with both ends coupled to the first front side member in a state of being spaced apart from each other in the longitudinal direction of the vehicle.

6. The vehicle body structure according to claim 2, wherein the suspension support member comprises:
a first leg portion having a lower end coupled to the first front side member;
a second leg portion having a lower end coupled to the first front side member at a rear of the first leg portion; and
a leg connection portion formed so as to extend in the longitudinal direction of the vehicle body, the leg connection portion being configured to connect upper ends of the first leg portion and the second leg portion to each other.

7. The vehicle body structure according to claim 6, wherein the suspension support member is coupled to a wheel house panel such that a space in which the first leg portion, the leg connection portion, and the second leg portion of the suspension support member are connected to each other is formed between the wheel house panel and the suspension support member.

8. The vehicle body structure according to claim 6, wherein, at a rear of a portion where the leg connection portion and the second leg portion of the suspension support member are connected to each other, a dash cross member is installed with a dash panel therebetween.

9. The vehicle body structure according to claim 8, wherein, at a rear of the first front side member, a dash lower longitudinal member is installed so as to extend in the longitudinal direction of the vehicle body.

10. The vehicle body structure according to claim 2, wherein a subframe is mounted to a lower side of the first front side member, and
wherein a front end module frame is coupled to a front of the first and second front side members in a state of connecting the first and second front side members of both sides of the front of a vehicle body to each other.

11. The vehicle body structure according to claim 10, wherein the subframe is formed in a quadrangular shape with two sides parallel to the first front side member, and
wherein the subframe is provided with subframe front protrusions protruding forward farther than the first front side member in front of both sides of the subframe.

12. The vehicle body structure according to claim 11, wherein an upper portion of the front end module frame extends in a transverse direction of the vehicle body to connect the first and second front side members to each other,
wherein a lower stiffener is installed between the subframe front protrusions of the subframe, and
wherein the front end module frame and the lower stiffener form an annular structure toward the front of the vehicle body.

13. The vehicle body structure according to claim 2, wherein the fender apron member is coupled to a side wall of the front additional member, and
wherein the vertical member is configured to connect lower sides of the fender apron member and the front additional member to an upper side of the first front side member.

14. The vehicle body structure according to claim 1, wherein a front end of the fender apron member is coupled to a front end of the first front side member; and
wherein the coupling member comprises:
a front additional member disposed in front of the suspension support member so as to extend in the longitudinal direction of the vehicle body, and
a vertical member configured to connect the front additional member and the first front side member to each other in a vertical direction.

15. A vehicle body structure comprising:
a front side member;
a suspension support member having both ends spaced apart from each other forward and rearward in a longitudinal direction of the front side member so as to be coupled to an upper side of the front side member;
a front additional member installed parallel to the front side member in front of the suspension support member; and
a vertical member installed so as to extend in a vertical direction, the vertical member being configured to connect a front end of the front additional member to the front side member.

16. The vehicle body structure according to claim 15, further comprising a fender apron member extending forward while curving diagonally upward on an outside of a vehicle body of the suspension support member so as to be gradually bent inwardly of the vehicle body, the fender apron member being coupled to the front additional member or the front side member.

17. A modular front vehicle body structure comprising left and right front sides, wherein each of the front sides comprises:
a first generally rectangular box structure;
a second generally rectangular box structure coupled to and sharing at least one component with the first generally rectangular box structure such that the second generally rectangular box structure is partially integral with the first generally rectangular box structure, wherein the first generally rectangular box structure is forward of the second generally rectangular box structure, wherein the second generally rectangular box structure includes a suspension support member; and
a fender apron member coupled to a front top portion of the first generally rectangular box structure and curvedly extending diagonally upward and rearward above and at least partially over the second generally rectangular box structure.

18. The structure of claim 17, wherein the suspension support member comprises:
a first leg portion having a first lower end coupled to a first front side member;
a second leg portion having a second lower end coupled to the first front side member rearward of the first leg portion, such that the first front side member connects the first lower end to the second lower end; and
a leg connection portion formed so as to extend in a longitudinal direction of the modular front vehicle body structure, the leg connection portion being configured to connect upper ends of the first leg portion and the second leg portion to each other.

19. The structure of claim 17, further comprising:
a subframe mounted to lower portions of the left and right front sides; and
a front end module frame coupled to fronts of the left and right front sides in a configuration connecting the fronts of the left and right front sides to each other at a front end of the modular front vehicle body structure, wherein the front end module frame forms an annular structure at the front end of the modular front vehicle body structure, wherein the annular structure is generally along a different plane than those of the first generally rectangular box structure and the second generally rectangular box structure.

20. The structure of claim 17, wherein the fender apron member is coupled to the first generally rectangular box structure in a configuration in which at least a part of the fender apron member is inserted into a front portion of the first generally rectangular box structure.
